(19) United States
(12) Patent Application Publication
(10) Pub. No.: US 2022/0018491 A1
(43) Pub. Date: Jan. 20, 2022

(54) SINGLE-PLATE BORESIGHT MECHANISM WITH INDEPENDENT MOVEMENT AND LOCKING CAPABILITY

(71) Applicant: FNSS SAVUNMA SISTEMLERI A.S., GÖLBASI (TR)

(72) Inventors: UGUR SITKI TÜRKYILMAZ, GÖLBASI (TR); ANIL CANKUR, GÖLBASI (TR); ÜMIT YERLIKAYA, GÖLBASI (TR)

(21) Appl. No.: 17/275,686

(22) PCT Filed: Oct. 26, 2020
(86) PCT No.: PCT/TR2020/050993

§ 371 Date: Mar. 12, 2021

(30) Foreign Application Priority Data
Nov. 15, 2019 (TR) 2019/17832

(51) Int. Cl. F16M 11/12; F16M 11/18; F16M 11/04; F16M 11/14; F41G 1/54

(52) U.S. Cl. CPC F16M 11/126; F16M 11/18; F16M 11/045; F16M 2200/024; F16M 11/046; F16M 11/048; F41G 1/54; F16M 11/14

(57) ABSTRACT

The invention is related to a single-plate boresight mechanism with independent movement and locking capability developed to be used in weapon and vision systems used in all kinds of vehicles. The invention is particularly related to a single-plate boresight mechanism with independent movement and locking capability which comprises at least one hinge (300) allowing the system to rotate in a Y-axis on the front side, at least one linear actuator (100) located behind the system and moving in the Y- and Z-axes, at least one spherical joint (200) ensuring contraction that will occur while the linear actuators (100) located behind move in the Y- and Z-axes to be eliminated.

### TECHNICAL FIELD

The invention is related to a single-plate boresight mechanism with independent movement and locking capability developed to be used in weapon and vision systems used in all kinds of vehicles.

The invention is particularly related to a single-plate boresight mechanism with independent movement and locking capability which comprises at least one hinge allowing the system to rotate in a Y-axis on the front side, at least one linear actuator located behind the system and moving in the Y- and Z-axes, at least one spherical joint ensuring contraction that will occur while the linear actuators located behind move in the Y- and Z-axes to be eliminated.

### STATE OF THE ART

In parallel with improvement of technology, there has been great improvements also in military systems. Primary purposes of these improvements are to make military vehicles fast, comfortable, useful and reliable. Today, boresight mechanisms which previously did not have independent movement capability, did not have independent locking capability or were controlled by more than one plate are used. Furthermore, springs are used to remove gaps in the system.

It is used in boresight systems on a completely-fixed platform used the present technique by instantly adjusting weapon or sight system by the user. There is no capability in terms of precision, thus it is not possible to make a fine adjustment.

In one-axis boresight mechanisms used in the present technique, elevation axis can be adjusted, whereas there is no movement capability in an axis of rotation.

In biaxial boresight mechanisms used in the present technique, it has the ability to rotate in two axes, similar to the system we have proposed. However, movements are not independent since rotational movements are carried out on each other. For this reason, the adjustment process has problems about precision and the adjustment process takes long time.

In biaxial boresight mechanisms with independent movement used in the present technique, both axes are independent from each other, but more than one plate and connection are used to achieve this independence. This situation increases size of the system and reduces its usability. Furthermore, this system cannot be locked and has quite low movement resolution and also needs springs to remove gaps.

In the systems used in the present technique, the system which do not have independent movement and locking capability will cause difficulty in using.

In the systems used in the present technique, it is needed to be used over and over in order to adjust sight system or direction which weapon points to.

In the systems used in the present technique, using more than one plate successively will create heavier and bulky products.

In the systems used in the present technique, springs are used to remove gaps between the plates used successively. These springs make it difficult to secure the load during working due to their flexibility.

In the systems used in the present technique, the difficulty in adjusting also prevents these mechanisms from being fully automated.

Consequently, for the solution of the above-mentioned problems existing in the present technique, the need for a new economical, useful, ergonomic and more functional single-plate boresight mechanism with independent movement and locking capability and insufficiency of the present solutions have required an improvement in the relevant technical field.

### AIM OF THE INVENTION

The present invention is related to a single-plate boresight mechanism with independent movement and locking capability developed to be used in weapon and sight systems used in all kinds of vehicles, which is developed in order to eliminate the above-mentioned disadvantages and bring new advantages to this relevant technical field.

The most important aim of this invention is to make accurate and precision adjustments and to provide the possibility of fixing due to the fact that movement capabilities and locking systems in these two axes are independent from each other.

Another aim of the invention is to make an accurate adjustment at one try since movement axes are independent.

Another aim of the invention is that system can be small and light since it is controlled by the system installed on a single plate.

Another aim of the invention is to achieve a gap-free movement without the need for springs, by means of using adjustment shaft and spherical bearings in the system.

Another aim of the invention is to make a system ready to be fully automatic by attaching servo motors to the adjustment pivots since the new adjustment mechanism is fully independent.

By means of this invention, more accurate sight control adjustment can be made with a lighter and smaller mechanism. The system used in the invention gives the advantage of weight, volume and precision.

A single-plate boresight mechanism with independent movement and locking capability developed to realize all the aims which are mentioned above and will emerge from the following detailed description;
a hinge allowing the system to rotate independently in the Y-axis on the front side,
linear actuators which are located behind the system and can move in the Y- and Z-axes,
a spherical joint ensuring contraction that will occur while the linear actuators located behind move in the Y- and Z-axes to be eliminated.

The structural and characteristic features and all advantages of the invention will be understood more clearly by means of the figures given below and the detailed description written by referring to these figures, and therefore the evaluation should be made by taking these figures and detailed description into consideration.

### FIGURES FOR UNDERSTANDING THE INVENTION

FIG. 1; is a drawing showing single-plate boresight mechanism with independent movement and locking capability subject to the invention.

FIG. 2; is a drawing showing single-plate boresight mechanism with independent movement and locking capability subject to the invention, as being demounted.

FIG. 3; is a drawing showing from the top a single-plate boresight mechanism with independent movement and locking capability subject to the invention.

FIG. 4; is a drawing showing section A-A of the single-plate boresight mechanism with independent movement and locking capability subject to the invention.

FIG. 5; is a drawing showing linear actuators and spherical joint portions of the single-plate boresight mechanism with independent movement and locking capability subject to the invention.

FIG. 6; is a drawing sectionally showing linear actuators and spherical joint portions of the single-plate boresight mechanism with independent movement and locking capability subject to the invention.

### REFERENCE NUMBERS

A. Block Simulating Vision and Weapon System

100. Linear Actuator

110. Elevation Table

120. Spherical bearing

130. Adjustment Pivot

140. Rotation Table

150. Lock System

151. Elevation Lock

152. Rotation Lock

153. Bolt 1

154. Bolt 2

200. Spherical Joint

210. Joint Chamber

220. Joint Assembly

230. Joint Bolt

300. Hinge

310. Elevation Hinge Pin

320. Rotary Fork

330. Rotation Hinge Pin

400. Load-Carrying Plate

500. Fixture

### DETAILED DESCRIPTION OF THE INVENTION

In this detailed description, preferred embodiments of the single-plate boresight mechanism with independent movement and locking capability are described only for a better understanding of the subject and without having any limiting effect.

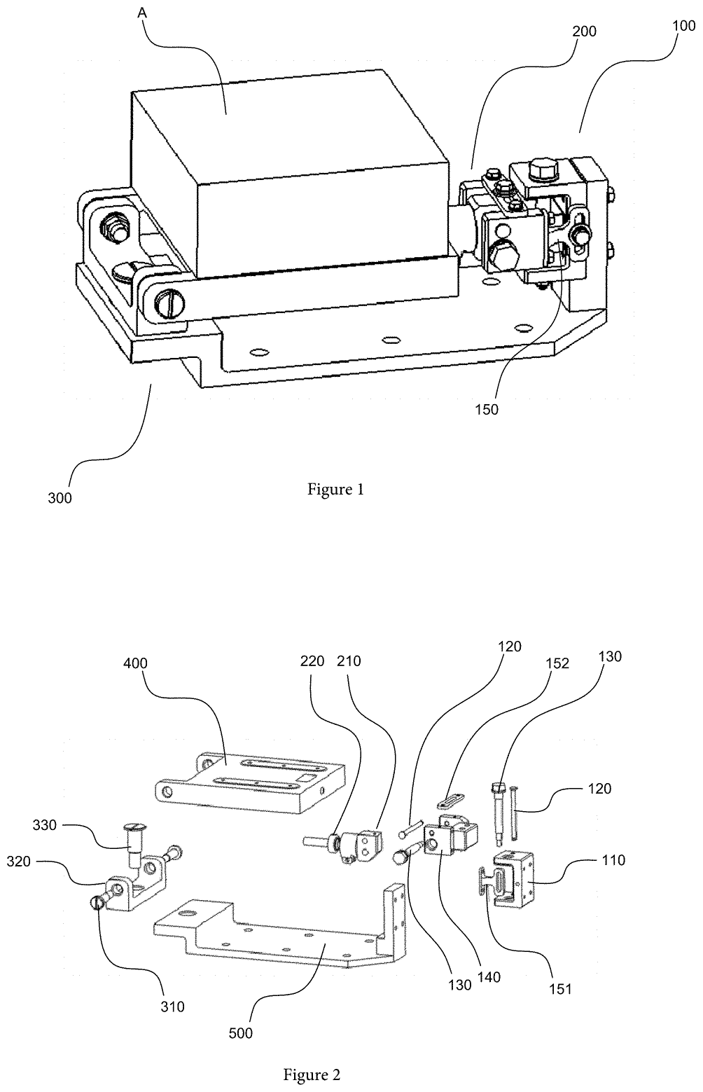

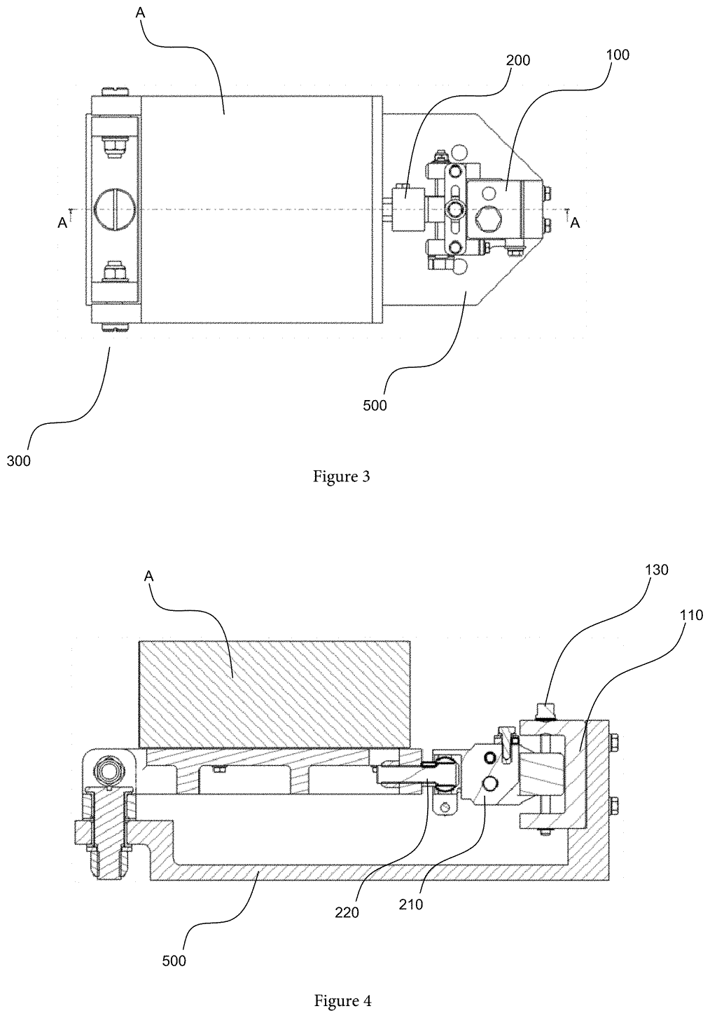

In FIGS. 1-4, single-plate boresight mechanism with independent movement and locking capability subject to the invention is shown. The invention is comprised of 3 main parts, namely linear actuators (100), spherical joint (200) and hinge (300). There is a hinge (300) allowing the system to rotate independently in the Y-axis on the front side and linear actuators (100) which can move in the Y- and Z-axes on the back side. In the invention, the rotary fork (320) provides independent rotational movement in the Y- and Z-axes in its position. Wherein the elevation table (110) bears the adjustment shaft (130) that delicately meets the movements in the Y- and Z-directions of the system, and the spherical bearing (120) that guides the adjustment pivot (130). Moreover, rotation table (140) bears the spherical bearing (120) and the adjustment pivot (130) that provide rotational movement in the Y-axis. The most important part of the system is to eliminate contractions which will occur while linear actuators (100) at the back move in the Y- and Z-axes, by means of the spherical joint (200) in the middle. Herein, the joint assembly (220) provides movement flexibility in the X-axis movement which the system requires during the rotation in the Y- and Z-axes, and meets angular orientations by means of the spherical joint. On the other hand, the joint chamber (210) moves in the Z-axis with the help of the spherical bearing (120) and the adjustment pivot (130), at the same time it bears the joint assembly (220) and allows its movement only in the X-direction. While the actuators (100) at the back move in the Y- and Z-axes, the need for extension and rotation arises due to the triangle formed. This need is met by the joint assembly (220) and movement of the joint assembly (220) in the X-axis in the joint chamber (210). In this case, the Z-axis is not affected when the system is rotated in the Y-axis, and the Y-axis is not affected when the system is rotated in the Z-axis. Therefore, rotary fork (320) provides independent rotational movements in the Y- and Z-axes. Rotary fork (320) is placed on fixture (500) and meets rotations of the system in the Y- and Z-axes. Elevation hinge pin (310) connects the load-carrying plate (400) to the rotary fork (320) and allows the rotation of the system in the Z-axis. Elevation hinge pin (330) connects rotary fork (320) to fixture (500) and allows the rotation of the system in the Y-axis. Since linear movements are realized with the help of adjustment pivots (130), in normal condition, the system does not need an external locking with the help of frictions. However, lock systems (150) are attached to the linear actuators (100) moving in the Y- and Z-axes at the back as a safety measure, in order not to impair sight adjustment due to the vibrations caused by environmental conditions. Thus, after sight adjustment is carried out, movement of the mechanism in the direction of rotation in the Z-axis with the elevation lock (151) and movement in the direction of rotation in the Y-axis with the rotation lock (152) are locked. Since the locking axes are perpendicular to the movement axes, sight adjustment is not impaired during locking. Herein, while load-carrying plate (400) serves to connect the load on it to be placed on the system, the fixture (500) serves to connect the system to any floor.

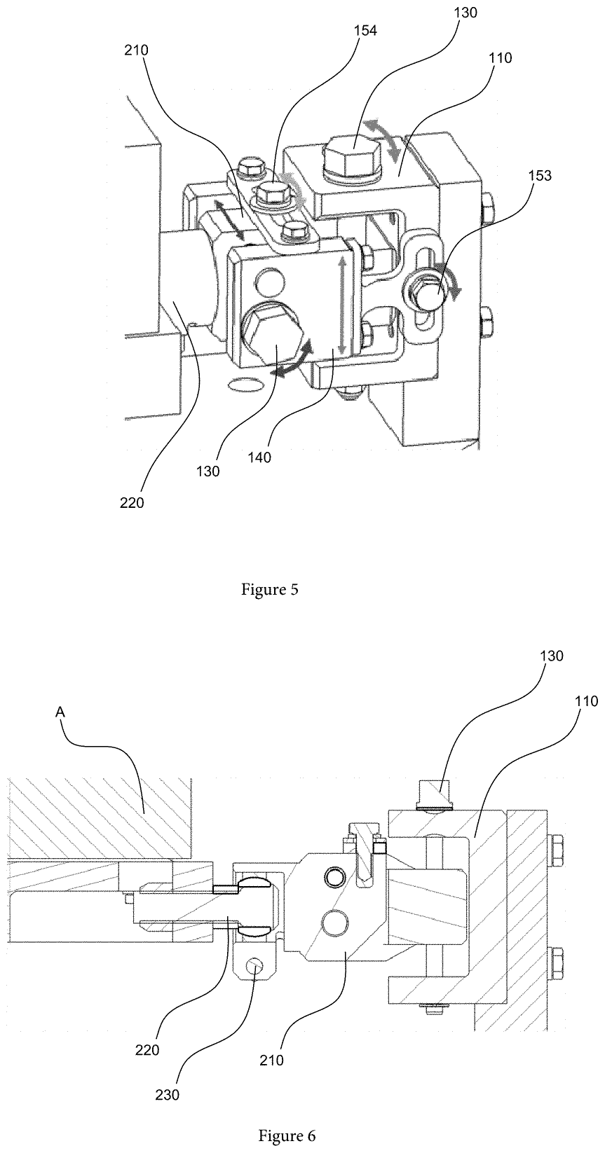

In FIG. 5, movement and locking capabilities of linear actuators (100) is shown. According to this, when adjustment pivot (130) is rotated to the right/left, rotation table (140) moves up/down, providing the mechanism with rotation capability in the Z-axis. Bolt 1 (153) is tightened to secure this axis in a specified position. Similarly, when adjustment pivot (130) in the direction of rotation is rotated upwards to the right/left, joint chamber (210) moves to the right/left, providing the mechanism with rotation capability in the Y-axis. Bolt 2 (154) is tightened to secure this axis in a specified position. Since locking direction is perpendicular to the rotating axis, rotating movement is not affected during locking and thus, sight adjustment is impaired.

The position of the joint chamber (210) on the linear actuators (100) and its connection with the joint assembly (220) are as in FIG. 6. The need for freedom that arises when the system makes a rotational movement in the Y- and Z-axes has been met with the freedom of rotation in the X-, Y- and Z-directions of the joint assembly (220) in the spherical joint chamber (210) and the freedom to movement only in the X-direction. After all of the adjusting and axis-locking processes are completed, the joint assembly (220) is locked inside the chamber (210) by tightening the joint bolt (230).

Protection scope of this application has been determined in the claims and it cannot be limited to those explained above for illustrative purposes. It is apparent that a person skilled in the art can introduce a novelty introduced in the invention by using similar configurations and/or apply this configuration in other fields with similar aims used in the relevant technique. Therefore, it is apparent that such configurations can be deprived of novelty and criteria regarding exceeding the state of art.

1- A single-plate boresight mechanism with independent movement and locking capability developed to be used in weapon and vision systems used in all kinds of vehicles, characterized by comprising;
at least one hinge (300) which allows the system to rotate independently in the Y-axis on the front side,
at least one linear actuator (100) which is located behind the system and can move in the Y- and Z-axes,
at least one spherical joint (200) ensuring contractions that will occur while the linear actuators (100) located behind move in the Y- and Z-axes to be eliminated.

2- Linear actuators (100) according to claim 1, characterized by comprising lock systems (150) which are attached to the linear actuators (100) moving in the Y- and Z-axes at the back, and prevent sight adjustment from impairing due to vibrations caused by environmental conditions.

3- Linear actuators (100) according to claim 1, characterized by comprising an adjustment pivot (130) which delicately meets the movements of the system in the Y- and Z-directions and an elevation table (110) which bears the spherical bearing (120) guiding the adjustment pivot (130).

4- Linear actuators (100) according to claim 1, characterized by comprising a rotation table (140) which bears spherical bearing (120) and adjustment pivot (130) providing the system with rotational movement in the Y-axis.

5- Spherical joint (200) according to claim 1, characterized by comprising a joint assembly (220) which provides movement flexibility in the X-axis movement which the system requires during the rotation in the Y- and Z-axes, and meets angular orientations by means of the spherical joint.

6- Spherical joint (200) according to claim 1, characterized by comprising a joint chamber (210) which moves in the Z-axis with the help of the spherical bearing (120) and the adjustment pivot (130), and at the same time, bears the joint assembly (220), allowing its movement only in the X-direction.

7- Spherical joint (200) according to claim 1, characterized in that the need for freedom that arises when the system makes a rotational movement in the Y- and Z-axes has been met with the freedom of rotation in the X-, Y- and Z-directions of the joint assembly (220) in the spherical joint chamber (210) and the freedom to movement only in the X-direction.

8- Spherical joint (200) according to claim 1, characterized by comprising a joint bolt (230) which locks the joint assembly (220) inside the chamber (210).

9- Single-plate boresight mechanism with independent movement and locking capability according to claim 1, characterized in that while actuators (100) move in the Y- and Z-axes, the need for extension and rotation due to the triangle formed is met by means of the joint assembly (220) and the movement of the joint assembly (220) in the joint chamber (210).

10- Single-plate boresight mechanism with independent movement and locking capability according to claim 1, characterized in that the Z-axis is not affected when the system is rotated in the Y-axis and the Y-axis is not affected when the system is rotated in the Z-axis, rotary fork (320) is provided with independent rotational movements.

11- Hinge (300) according to claim 1, characterized by comprising an elevation hinge pin (310) which connects the load-carrying plate (400) to the rotary fork (320) and allows the system to rotate in the Z-axis.

12- Hinge (300) according to claim 1, characterized by comprising an elevation hinge pin (330) which connects the rotary fork (320) to the fixture (500) and allows the system to rotate in the Y-axis.

13- Lock systems (150) according to claim 2, characterized in that after sight adjustment is carried out, movement of the mechanism in the direction of rotation in the Z-axis with the elevation lock (151) and movement in the direction of rotation in the Y-axis with the rotation lock (152) are locked.

14- Lock systems (150) according to claim 2, characterized in that the rotation table (140) moves upward/downward by rotating the adjustment pivot (130) to right/left and the bolt 1 (153) is tightened in order to secure rotation of the mechanism in the Z-axis.

15- Lock systems (150) according to claim 2, characterized in that the joint chamber (210) moves to right/left by rotating the adjustment pivot (130) in the direction of the rotation to right/left, and the bolt 2 (154) is tightened in order to secure rotation of the mechanism in the Y-axis.
